(19) United States
(12) Patent Application Publication
(10) Pub. No.: US 2006/0076521 A1
(43) Pub. Date: Apr. 13, 2006

(54) Device for influencing, deflecting and/or reflecting terrestrial and atmospheric radiation or fields

(75) Inventor: Adolf Wiebecke, Oberalm (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Geowave-Research Forschung une Handel GmbH

(21) Appl. No.: 10/546,184

(22) PCT Filed: Jan. 15, 2004
(86) PCT No.: PCT/AT04/00005

§ 371 Date: Aug. 18, 2005

(30) Foreign Application Priority Data
Feb. 20, 2003 (AT) GM105/2003

(51) Int. Cl. G21F 3/00

(52) U.S. Cl. 250/515.1

(57) ABSTRACT

The invention relates to a device for influencing, deflecting and/or reflecting terrestrial and atmospheric radiation or fields, especially from geopathogenic zones. The inventive device is characterized by a shield-shaped element (1) which can be attached to the wall or ceiling of a room. At least the surface (2) of the shield-shaped element (1) facing the room is provided with an electrically conductive, wave-like structure.

The invention relates to a device for influencing, deflecting and/or reflecting terrestrial and atmospheric radiation or fields, in particular from geopathogenic zones.

As has already been described in a large number of scientific papers, terrestrial radiation or fields and atmospheric radiation from diverse natural or artificial sources exert noxious effects on humans, animals and vegetation, if such energy flows are concentrated in so-called noxious zones or are superposed in a noxious fashion. Such noxious zones may exist for instance above water veins or tectonic faults and are termed geopathogenic zones in the literature. In the interior of buildings or apartments such fields or radiations may be amplified or superposed or noxiously deflected in particular by metallic structures such as beams, pipes or masts.

From DE 38 37 622 A1 a device has become known in this context for the shielding and absorption of radiation of electro-magnetic DC-fields originating in subterranean water veins. The device uses a magnetic plate which is mounted against the direction of radiation, whose length depends on the width of the radiation field and which thus shields from the terrestrial radiation. Above and behind the magnetic plate space is free of radiation. The magnetic plate is made from sheet steel and is magnetised by a DC electromagnet or by a rod-shaped permanent magnet.

From DE 196 38 344 C2 a metal shielding foil is known, which has on one side alternating, irregularly curved hills and valleys, with no plane intermediate region existing between neighbouring hills and valleys.

From DE 34 33 292 A1 a device is known for the directed deflection or shielding of terrestrial rays coming from geopathogenic zones or other noxious sources, such as TV-antennas or high-voltage masts. The device consists of a V-shaped multi-element rod antenna made of conductive material, at whose upwardly directed opening a reflector shield is provided which deflects radiation downwards. The device is placed in a cylindrical housing serving as a container for filling material and as a support. The bottom of the housing may be configured as a reflector for increased effectiveness. The V-shaped rod antenna, when placed in a noxious zone, generates radiation which is reflected by the shield or the reflector in a suitable way. This radiation changes the noxious field and thus eliminates the noxious effect.

From EP 0 642 807 A2 there has become known in this context an essentially rectangular pad which is provided with a series of magnetic strips aligned parallel to the short side of the rectangular pad. A conductive element consisting of a bundle of conductors is positioned at the edge of the pad, whose characteristic vibrations are excited by the earth's magnetic field, and which thus reduces the geopathogenic influences in the area of the pad. Unfortunately, the effect is essentially confined within the dimensions of the pad.

From WO 88/01184 A1 there is finally known a device for the shielding of radiations, grid net works and grid lines, which consists of overlapping elements in the form of plastic foils or wax plates, which are arranged in the shape of a battery, and which each by a special colouring or a special coating shield from a certain type of radiation or grid network.

It is an object of the present invention, on the basis of state-of-the-art designs, to further improve a device for influencing terrestrial and atmospheric radiations and fields in such a way that a compact design is achieved whilst effectiveness is improved or at least equal, and that simple deployment of the device is possible in the rooms or buildings to be shielded. A further aim is an aesthetically pleasing design of the device.

The invention attains its objective by proposing a shield-shaped element which can be fastened to the wall or the ceiling of a room, with at least that surface of the shield-shaped element which faces into the room having an electrically conducting wavelike structure. The element according to the invention may thus be mounted directly in the living, working or sleeping area, the device acting as a radiation reflector reducing or quenching the noxious components of the original radiation by resonance or interference effects. Essentially the regions of the room situated in the radiation region of the shield-like element will be kept radiation-free. The device of the invention will thus act as a harmony and energy sail at the location where it is used.

The wavelike structure of the shield-shaped element may be made of steel, aluminium, copper or another suitable metal or metal alloy, but it is also possible to use an electrically insulating supporting structure, such as Plexiglas, which is provided with a metal coating.

It has been found to be of particular advantage if the shield-shaped element has a circular arc as boundary at either end of its longitudinal extension, with the centres of the circular arcs lying on a symmetry axis of the shield-shaped element. Another preferred, particularly elegant, variant of the shield-shaped element has an elliptic boundary.

For special adaptation to the given noxious zone or the room to be shielded, it is of particular advantage, if a sheet element or a coating of electrically conducting material is applied to the surface of the shield-shaped element facing the room, with the sheet element or the coating preferably being configured as a circle. Shape, size and material of the sheet or coating are adapted to the given situation following radiesthetic measurement series.

The sheet element or the coating consists of a material which differs from the material of the conductive surface of the shield-shaped element, for instance gold, silver, platinum, copper, tin or an alloy of these metals. The centre of the smaller circular arc boundary may for instance be coated with silver while the centre of the larger circular arc boundary has a coating of gold. In the case of an elliptic boundary the coatings may be applied at the focal points.

According to the invention it is of further advantage if the ratio R/r of the radii R and r of the circular arc boundaries is that of the golden section, i.e. about 1.618.

Besides the wavelike structure of the surface, with a wave distance a of 20 to 60 mm, preferably 26.3 to 33.5 mm, and a preferred wave height h of 3 to 6 mm, the shield-shaped element, in a further development of the invention, is provided with a wave-shaped, preferably sinusoidal, curvature in its longitudinal extension, upon which the wavelike structure of the surface is superimposed. This wave-shaped curvature of the shield-shaped element has a wavelength L, which is approximately equal to the total length of the shield-shaped element.

Further positive aspects may be realised according to the invention, if the shield-shaped element is provided with a receptor for a vessel filled with informed water.

The term “informed water” in this context is applied to natural or especially treated water, which has encoded certain energetic and/or material information in the cluster structure of the water molecules. This can be explained by the dipole character of the water molecule, which in liquid water is not present as a single molecule, but forms diverse arrangements or configurations of molecule groups, i.e. so-called cluster structures. The binding energy of hydrogen bridges is high, causing the water molecules to form crystal-like structures. In non-informed water the hydrogen bridges are continuously breaking down and new clusters are formed. “Water information” causes an impressed, i.e. stable cluster structure due to a resonance coupling which stabilises the hydrogen bridges. This cluster structure can only be destroyed by energy input, such as strong magnetic fields, laser- or X-rays, heat and pressure. The cluster eigenvalues (=information) occurring in this process lie in the hertz to kilohertz range.

The informed water, which is contained in a glass vessel attached to the shield-shaped element, transfers its information unto the shield-shaped element, where an improved influencing, deflecting or reflecting of terrestrial or atmospheric radiation in the region of the shield-shaped element will be observed. It can also be shown that the noxious effects of fields or radiations from geopathogenic zones or artificial technical sources on humans or other organisms are significantly reduced and that the achieved improvement of the room climate results in a kind of harmonising equilibration. People who live and work in such rooms exhibit considerably fewer symptoms of stress and have improved regulatory and defensive powers, which again may have a positive effect on well-being, on work performance and on aggressive tendencies.

A similar effect may be attained if a receptacle for a crystal element is provided at the shield-shaped element, as proposed in a variant of the invention.

By placing one or more permanent magnets on the surface of the shield-shaped element a further positive influence on the room climate can be achieved.

The invention will now be explained in more detail with reference to the attached drawings showing different embodiments of the invention.

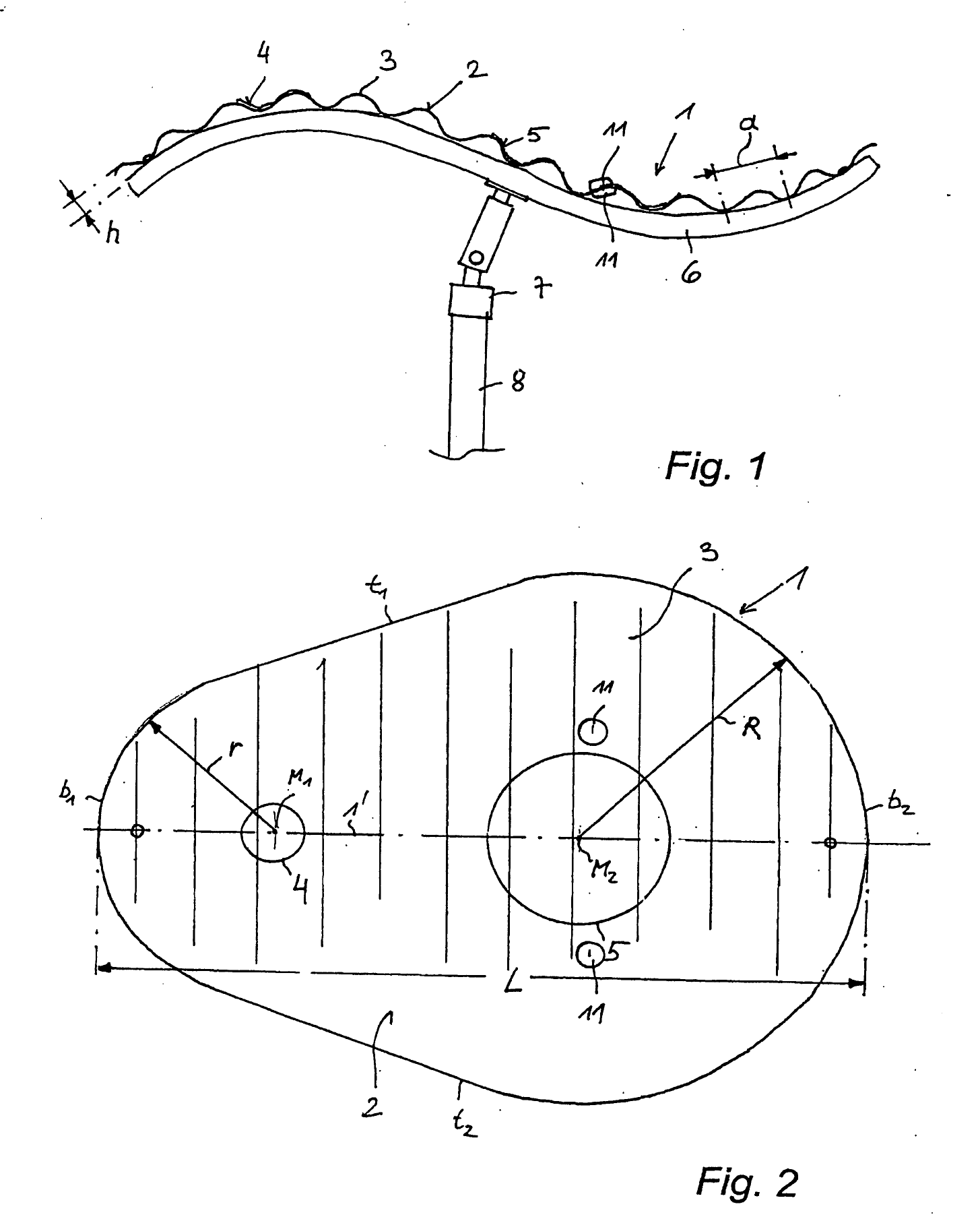

FIG. 1 shows a side view of a first variant of the device according to the invention for influencing, deflecting or reflecting terrestrial or atmospheric radiations or fields;

FIG. 2 shows the device of FIG. 1 in a view from above;

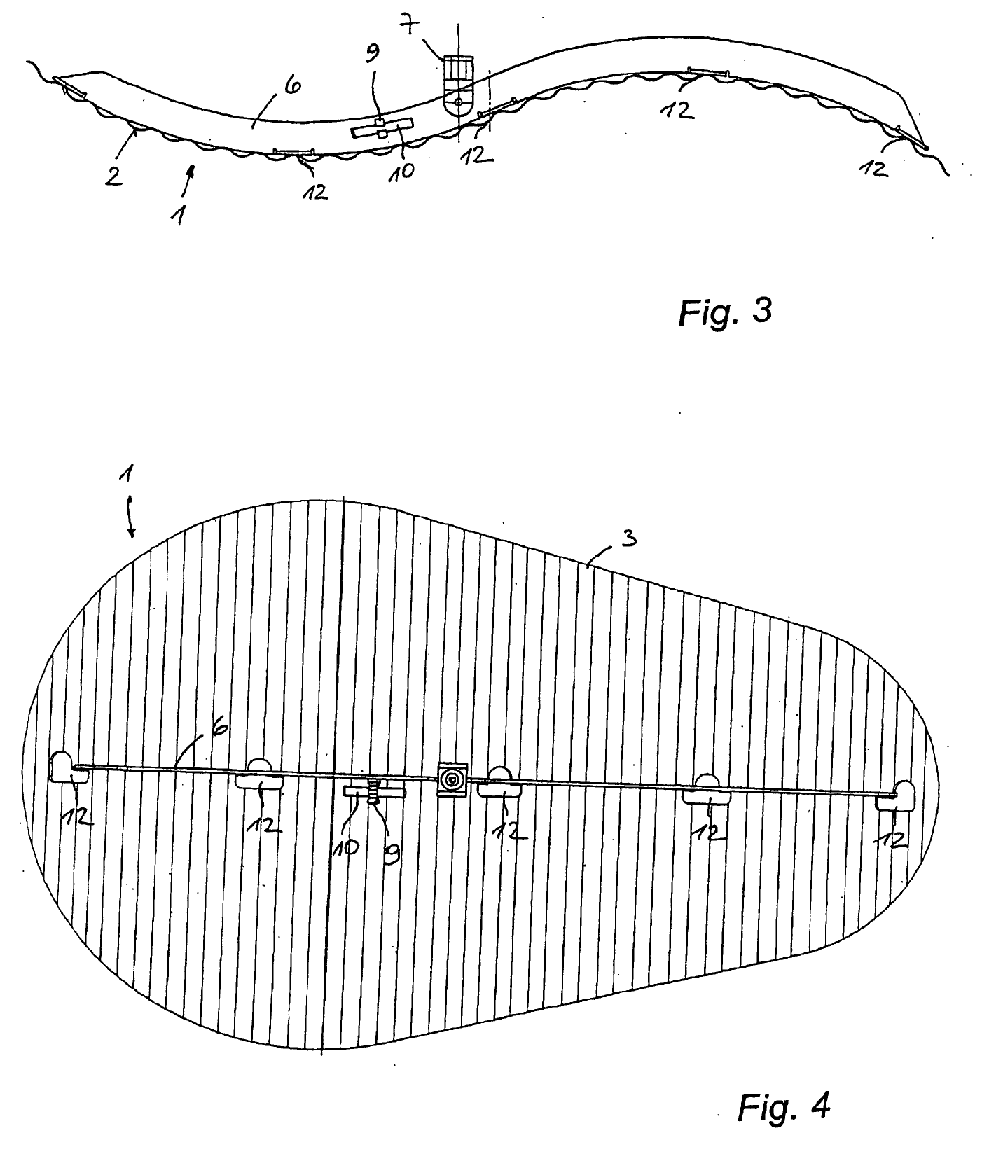

FIG. 3 is a side view of a second variant of the device according to the invention;

FIG. 4 is a view from above;

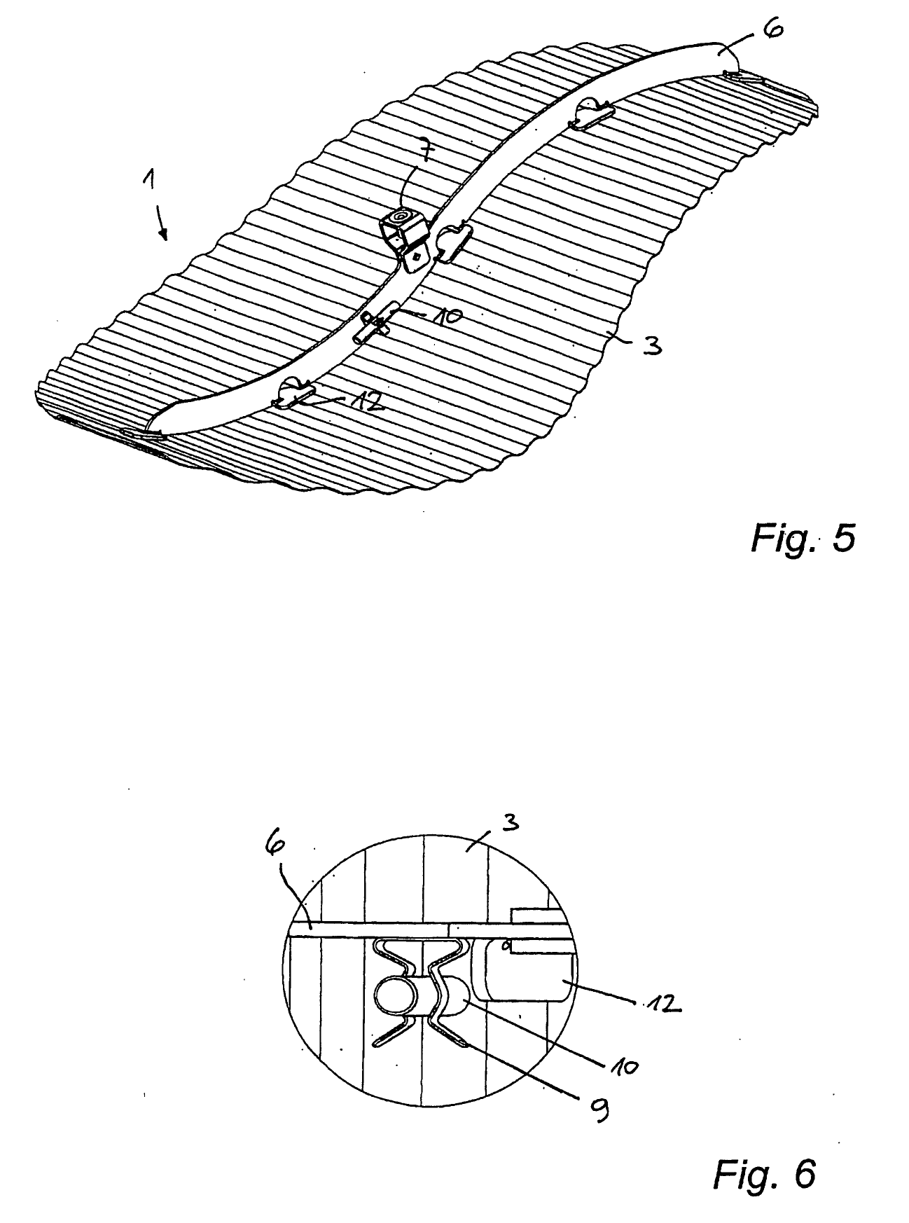

FIG. 5 is an oblique view;

FIG. 6 is a detail of the second variant.

The device for influencing terrestrial and atmospheric radiations or fields shown in FIGS. 1 and 2, comprises a shield-shaped element 1 to be attached to the wall or ceiling of a room, whose surface 2 facing the room is a wavelike, electrically conductive, structure 3. In the example shown the wavelike structure 3 is realised from corrugated Al/Mg sheet metal, but it would also be possible to form a wavelike structure from an insulating material, such as wood, plastic or Plexiglas and to furnish this structure with a metallic coating.

The shield-shaped element 1 has circular arc boundaries b₁ and b₂ in its longitudinal direction, defined by their centres M₁ and M₂ situated on the symmetry-axis 1′ and by the radii r and R, which boundaries are laterally connected by tangential sections t₁ and t₂. The tangential sections could also be curved towards the inside or the outside.

In the example shown the shield-shaped element 1 has two coatings 4, 5 in the form of circular discs in the area of the centres M₁ and M₂, the smaller coating 4 with centre M₁ being made of silver and the larger coating 5 with centre M₂ of gold, for instance.

As can be seen in particular from the side view of FIG. 1, the shield-shaped element 1 has a sinusoidal curvature along its longitudinal extension, whose wavelength L corresponds to the total length of the shield-shaped element 1. The troughs and peaks of the wavelike structure 3 are perpendicular to the longitudinal extension, respectively the symmetry axis 1′, of the shield-shaped element 1.

At least the surface 2 of the wavelike structure 3 facing into the room may be varnished or coated. In the case of aluminium or an aluminium alloy it may be anodised, for example.

The shield-shaped element 1 may for instance be mounted on a sinusoidal supporting profile 6, which is provided with an articulated holder 7 for attachment to wall or ceiling. The holder 7 or parts 8 of the holder 7 are preferably made from an electrically insulating material.

On the surface of the shield-shaped element 1 one or more permanent magnets 11 may be placed, which may be symmetrically attached on both sides of the coating 5, as shown in FIG. 2. Preferably, the magnets 11 are attached by placing them pairwise on the two sides of the corrugated aluminium sheet.

The embodiment of the invention shown in FIGS. 3 to 6 has a supporting part 6 with notched attaching elements 12 for the wavelike structure 3 (corrugated Al-sheet, for example). The sinusoidal curvature of the shield-shaped element 1 is determined by the shape of the support 6. A receptacle 9 for a vessel 10 filled with informed water (see FIG. 6) is provided on the shield-shaped element 1, the receptacle 9 being placed on the side of element 1 facing away from the room, and preferably laterally on the support 6 of the element 1. It is also possible in a variant of the invention to provide a receptacle (not shown) for a crystal element on the shield-shaped element 1.

Following is an exemplary list of dimensions and characteristics of the device of the invention.

| | |
|---|---|
| wave distance of wavelike structure: | a = 26.3 to 33.5 mm |
| wave height of wavelike structure: | h = 3.0 to 15.0 mm |
| material of wavelike structure: | Al/Mg alloy |
| total length of shield: | 100 to 3,000 mm |
| ratio of radii R/r: | 1.618 approx. |
| surface: | anodised |

1. Device for influencing, deflecting and/or reflecting terrestrial and atmospheric radiation or fields, in particular from geopathogenic zones, wherein a shield-shaped element which may be fastened to the wall or the ceiling of a room, where at least the surface of the shield-shaped element facing the room is provided with an electrically conductive, wavelike structure.

2. Device according to claim 1, wherein the shield-shaped element has circular arc boundaries at both ends of its longitudinal extension with the centres of the boundaries located on a symmetry axis of the shield-shaped element.

3. Device according to claim 1, wherein the shield-shaped element (1) has an elliptic boundary.

4. Device according to claim 1, wherein a sheet element or a coating of electrically conducting material is applied to the surface of the shield-shaped element facing the room, said sheet element or coating preferably being configured as a circular disc.

5. Device according to claim 4, wherein the sheet element or coating is centred on at least one of the centres of the circular arc boundaries, or on at least one of the focal points of the elliptic boundary.

6. Device according to claim 4, wherein the sheet element or coating is made of gold, silver, platinum, copper, tin or an alloy of these metals.

7. Device according to claim 2, wherein the ratio R/r of the radii R and r of the circular arc boundaries equals the ratio of the golden section, i.e. approximately 1.618.

8. Device according to claim 1, wherein the shield-shaped element has a wavelike, preferably sinusoidal curvature in its longitudinal extension, upon which the wavelike structure of the surface is superimposed.

9. Device according to claim 1, wherein the wavelike curvature of the shield-shaped element has a wavelength L approximately equal to the total length of the shield-shaped element.

10. Device according to claim 1, wherein the wavelike structure of the surface has a wave distance a of 20 mm to 60 mm, preferably 26.3 to 33.5 mm, and a wave height h of 3 mm to 6 mm.

11. Device according to claim 10, wherein troughs and peaks of the wavelike structure are normal to the symmetry axis of the shield-shaped element.

12. Device according to claim 11, wherein the wavelike structure of the shield-shaped element consists of steel, aluminum, copper, a metallic alloy or a metallic coating on an insulating supporting base.

13. Device according to claim 12, wherein at least the surface of the wavelike structure which faces the room is varnished or coated.

14. Device according to claim 13, wherein the shield-shaped element is mounted on a supporting part adapted to the wavelike curvature of said element, which supporting part is provided with at least one articulated holder for attachment to the wall or ceiling.

15. Device according to claim 1, wherein the shield-shaped element is provided with a receptacle for a vessel filled with informed water.

16. Device according to claim 1, wherein the shield-shaped element is provided with a receptacle for a crystal element.

17. Device according to claim 15, wherein the receptacle is placed on the side of the shield-shaped element facing away from the room, and preferably laterally on the supporting part of the shield-shaped element.

18. Device according to claim 1, wherein one or more permanent magnets are attached to the surface of the shield-shaped element.
